(19) United States
(12) Patent Application Publication
(10) Pub. No.: US 2021/0097424 A1
(43) Pub. Date: Apr. 1, 2021

(54) DYNAMIC SELECTION OF FEATURES FOR TRAINING MACHINE LEARNING MODELS

(71) Applicant: Microsoft Technology Licensing, LLC, Redmond, WA (US)

(72) Inventors: Luxin Kang, Clyde Hill, WA (US); Divyakumar Menghani, Sunnyvale, CA (US)

(21) Appl. No.: 16/583,837

(22) Filed: Sep. 26, 2019

(51) Int. Cl. G06N 20/00; G06N 5/04; G06Q 10/10

(52) U.S. Cl. CPC G06N 20/00; G06Q 10/1053; G06N 5/046

(57) ABSTRACT

Apparatuses, computer readable medium, and methods are disclosed for dynamic selection of features for training a machine learning model. A method includes using predetermined rules to determine first members that are hiring managers and second members that are not hiring managers, where the members are part of an online connection system. The method further includes selecting first features based on the predetermined rules, member activity data, member profile data, and member activity and usage data. The method further includes training a machine learning model to determine values for coefficients, where the machine learning model determines a score that indicates whether a member is a hiring manager. The method may further includes selecting a second features from the first features, where a feature of the first features is dropped if a value of a corresponding coefficient is lower than a threshold, and randomly selecting new features for the second features.

### TECHNICAL FIELD

Some embodiments pertain to dynamically determining features to train machine learning models. The machine learning model may determine a likelihood for whether a member of a connection network system is a hiring manager. Some embodiments pertain to training the machine learning model based on determining relevant features using a set of members assumed to be hiring managers and then iterating to determine new features to use to train the machine learning model.

### BACKGROUND

A connection network system may include hundreds of millions or billions of members. Much of the value of the connection network is in providing services to the members. The services offered by the connection network system to members are constantly being updated. Some of the services that members find valuable require the system to determine characteristics of the members. For example, a characteristic of a member may be whether the member is a hiring manger for a job offered on the connection network system. If the connection network system can determine which members are hiring managers, then the system may provide services to the hiring managers and services to other members to access the hiring managers. However, members are reluctant to enter information about themselves such as whether they are a hiring manager or not.

### DESCRIPTION OF THE DRAWINGS

FIG. 1 is a block diagram of a connection network system, in accordance with some embodiments;

FIG. 2 illustrates a system for determining hiring managers, in accordance with some embodiments;

FIG. 3 illustrates a system including the filter data module, in accordance with some embodiments;

FIG. 4 illustrates a system for determining hiring managers, in accordance with some embodiments;

FIG. 5 illustrates a system to adjust features, in accordance with some embodiments;

FIG. 6 illustrates a member, in accordance with some embodiments;

FIG. 7 illustrates feature coefficients, in accordance with some embodiments;

FIG. 8 illustrates a user interface for determining hiring managers, in accordance with some embodiments;

FIG. 9 illustrates a graph of a number of predicted hiring managers as a function of a value of the threshold, in accordance with some embodiments;

FIG. 10 illustrates a rule-based system to determine hiring managers, in accordance with some embodiments;

FIG. 11 illustrates a comparison of the rule-based system to determine hiring managers 1000 vs. the prediction model, in accordance with some embodiments;

FIG. 12 illustrates a system for generating successful offers, in accordance with some embodiments;

FIG. 13 illustrates a graph of an ubiquitous participation (UP) job funnel with different hiring manager scores, in accordance with some embodiments;

FIG. 14 illustrates a method for dynamic selection of features for training a machine learning model, in accordance with some embodiments; and

FIG. 15 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for dynamic selection of features for training a machine learning model. In the following description, for purposes of explanation, numerous specific details are set forth in order to provide a thorough understanding of the various aspects of different embodiments of the present invention. It will be evident, however, to one skilled in the art, that disclosed embodiments may be practiced without all of the specific details and/or with variations, permutations, and combinations of the various features and elements described herein.

Apparatuses, computer readable media, and methods are disclosed for training a machine learning model to determine which members of a connection network system are hiring managers of a company. There may be billions of members of an online connection network system. The online connection network system collects a large amount of information from the members based on member profiles, member activity, and member usage information. Determining which members of the online connection network system are hiring managers enables the online connection network system to operate more efficiently by offering services customized for the hiring managers, e.g., by offering a service to list job postings for the hiring manager. In another example service, the connection network system may offer a service to members that are job seekers that allows the job seekers to contact a hiring manger of a job the job seeker is interested in.

A technical problem is to determine how to train a machine learning model to determine whether a member of a connection network system is a hiring manager. The connection network system may keep a large amount of information regarding each member, e.g., as part of the member profile, member activity, and member usage information. The number of possible features to use to train the machine learning model may be in the many thousands. Additionally, since the connection network system is constantly being updated, the possible features may constantly be changing.

Conventional hand-coding rules to determine which members are hiring managers is too time consuming and requires constant maintenance as the online connection network system offers new services and generates new features. Additionally, hand-coding rules may miss many hiring managers as the person hand-coding the rules may not determine the best rules to determine whether a member is a hiring manager.

The system for training a machine learning model to determine which members of a connection network system are hiring managers of a company, “system”, uses a small number of members that are known to be hiring managers, e.g., based on a few rules that the member is a hiring manager or by hand verification. The system extracts some features from the members profiles, members activity, and members usage information of the members. The system then trains a machine learning model using the small set of known hiring managers to determine how well the extracted features are at predicting whether the member is a hiring manager. The system iterates by adding or subtracting features and retraining the machine learning model and retesting the machine learning model using the known hiring managers.

The system determines which features are better or best at determining whether a member is a hiring manager by iterating on different subsets of the features. Additionally, as more services are added to the online connection network system and/or as hiring managers change their behaviour, the system will adjust by dynamically learning a new set of features to use to train the machine learning model to determine if a member is a hiring manager.

Moreover, the machine learning model produces a score or output that determines a likelihood that a member is a hiring manager. This enables other members to determine how certain they would like to be that a member is a hiring manager before interacting with the member. Additionally, the online connection network system may use the score to determine whether to interact with a member, e.g., only make an offer for a free listing of a job posting if the probability of the member being a hiring manager is greater than 80 percent.

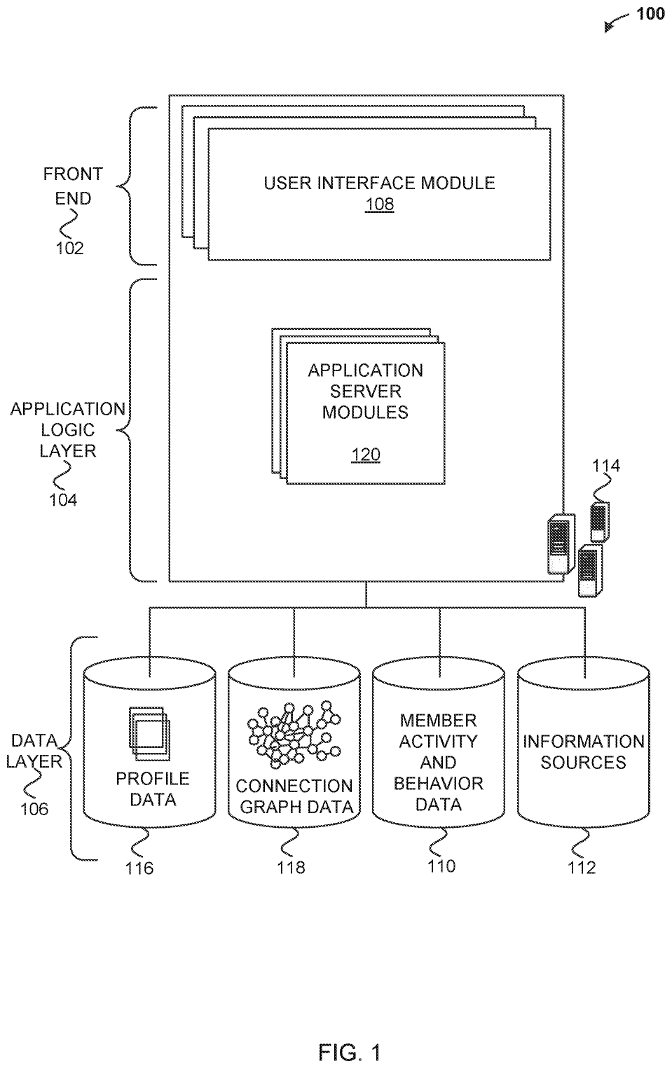

FIG. 1 is a block diagram of a connection network system 100, in accordance with some embodiments. The connection network system 100 may be based on a three-tiered architecture, comprising a front-end layer 102, application logic layer 104, and data layer 106. Some embodiments implement the connection network system 100 using different architectures. The connection network system 100 may be implemented on one or more computers 114. The computers 114 may be servers, personal computers, laptops, portable devices, etc. The computers 114 may be distributed across a network. The connection network system 100 may be implemented in a combination of software, hardware, and firmware.

As shown in FIG. 1, the front end 102 includes user interface modules 108. The user interface modules 108 may be one or more web services. The user interface modules 108 receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer 106 includes profile data 116, connection graph data 118, member activity and behaviour data 120, and information sources 112. Profile data 116, connection graph data 118, and member activity and behaviour data 120, and/or information sources 112 may be databases. One or more of the data layer 106 may store data relating to various entities represented in a connection graph. In some embodiments, these entities include members, companies, and/or educational institutions, among possible others. Consistent with some embodiments, when a person initially registers to become a member of the connection network system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current position title including name of company, position description, industry, employment history, skills, professional organizations, and so on. This information is stored as part of a member's member profile, for example, in profile data 116. The data layer 106 may include data that is used as described herein, e.g., features 210, weights 214, etc.

With some embodiments, a member's profile data will include not only the explicitly provided data, but also any number of derived or computed member profile attributes and/or characteristic, which may become part of one of more of profile data 116, connection graph data 118, member activity and behaviour data 110, and/or infoi niation sources 112.

Once registered, a member may invite other members, or be invited by other members, to connect via the connection network service. A company may be a member. A “connection” may require a bi-lateral agreement by the members, such that both members acknowledge the establishment of the connection, e.g., connections 318 or connection 418. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the connection graph data 118. With some embodiments the connection graph data 118 may be implemented with a graph database, which is a particular type of database that uses graph structures with nodes, edges, and properties to represent and store data. In this case, the connection graph data 118 reflects the various entities that are part of the connection graph, as well as how those entities are related with one another.

With various alternative embodiments, any number of other entities might be included in the connection graph data 118, and as such, various other databases may be used to store data corresponding with other entities. For example, although not shown in FIG. 1, consistent with some embodiments, the system may include additional databases for storing information relating to a wide variety of entities, such as information concerning various online or offline people, position announcements, companies, groups, posts, job posts, slide shares, and so forth.

With some embodiments, the application server modules 120 may include one or more activity and/or event tracking modules, which generally detect various user-related activities and/or events, and then store information relating to those activities/events in, for example, member activity and behaviour data 110. For example, the tracking modules may identify when a user makes a change to some attribute of his or her member profile, or adds a new attribute and may trigger waterloo member-attribute processor to store the change in member activity and behaviour data 110. Additionally, a tracking module may detect the interactions that a member has with different types of content. For example, a tracking module may track a member's activity with respect to position announcements, e.g. position announcement views, saving of position announcements, applications to a position in a position announcement, explicit feedback regarding a position announcement (e.g., not interested, not looking, too junior, not qualified, information regarding the position the member would like, a location member wants to work, do not want to move, more like this, etc.), position search terms that may be entered by a member to search for position announcements.

Such information may be used, for example, by one or more recommendation engines to tailor the content presented to a particular member, and generally to tailor the user experience for a particular member. Information sources 112 may be one or more additional information sources. For example, information sources 112 may include external sources that include job posting and company information that may be used by import jobs module 202 to generate jobs 208.1.

The application server modules 120, which, in conjunction with the user interface module 108, generate various user interfaces (e.g., web pages) with data retrieved from the data layer 106. In some embodiments, individual application server modules 120 are used to implement the functionality associated with various applications, services and features of the connection network service. For instance, a messaging application, such as an email application, an instant messaging application, or some hybrid or variation of the two, may be implemented with one or more application server modules 120. Of course, other applications or services may be separately embodied in their own application server modules 120. In some embodiments applications may be implemented with a combination of application service modules 120 and user interface modules 108. For example, contact talent seeker module 902 or confirm job module 1002 may be implemented with a combination of back-end modules, front-end modules, and modules that reside on a user's computer (not illustrated). For example, the connection network system 100 may download a module to a web browser running on a user's computer, which may communicate with an application server module 120 running on a server 114 which may communicate with a module running on a back-end database server (not illustrated).

The connection network system 100 may provide a broad range of applications and services that allow members the opportunity to share and receive information, often customized to the interests of the member. For example, in some embodiments, the connection network system 100 may include generate identify talent seeker module 216, which may be an application server module 120.

With some embodiments, members of a connection network service may be able to self-organize into groups, or interest groups, organized around a subject matter or topic of interest. Accordingly, the data for a group may be stored in connection graph data 118. When a member joins a group, his or her membership in the group may be reflected in the connection graph data 118. In some embodiments, members may subscribe to or join groups affiliated with one or more companies. For instance, with some embodiments, members of the connection network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the connection graph and modelled with the connection graph data 118.

In some embodiments, the connection network system 100 may include identify talent seeker module 216, which includes or has an associated publicly available API that enables third-party applications to invoke the functionality of the respective module or application.

In some embodiments the connection network system 100 is a social networking system. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a connection network system, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the disclosed embodiments are by no means limited to such architecture.

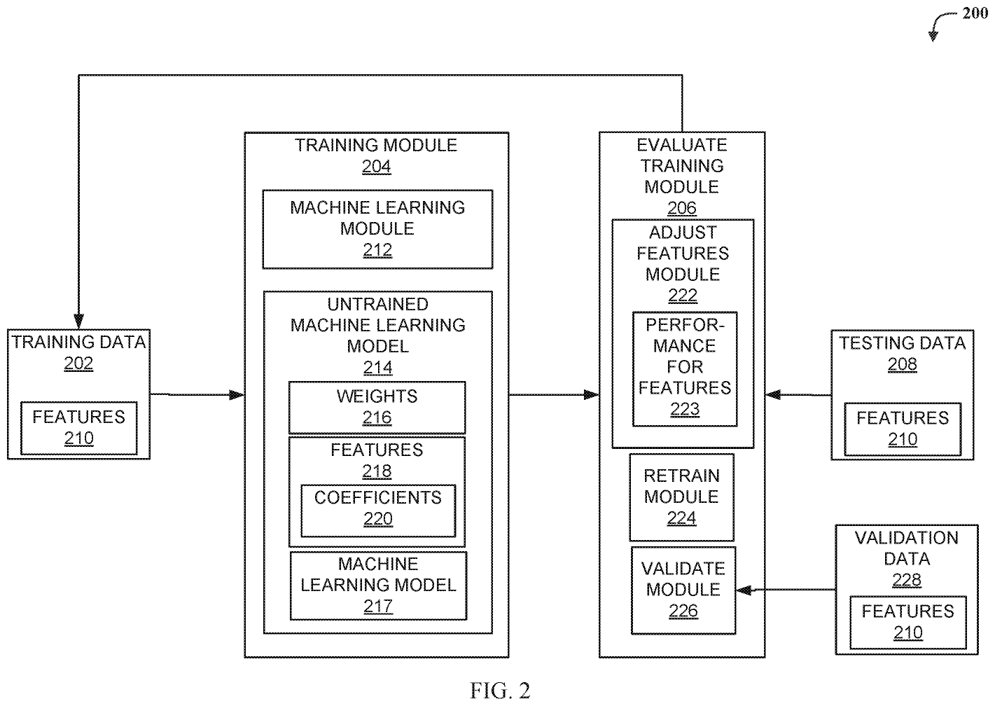

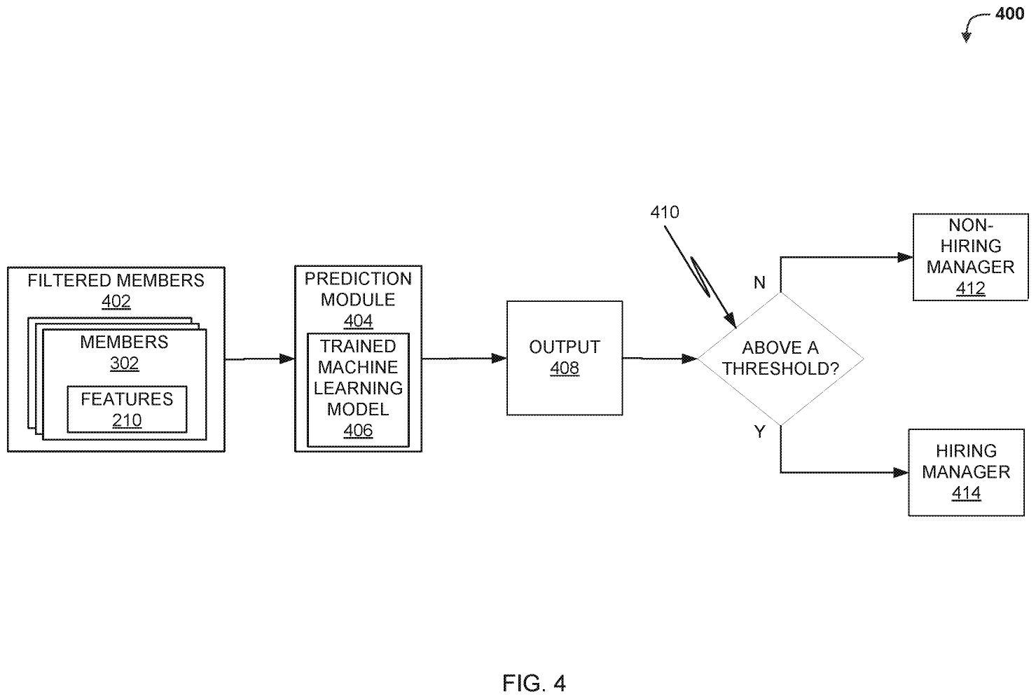

FIG. 2 illustrates a system 200 for determining hiring managers, in accordance with some embodiments. Illustrated in FIG. 2 is training data 202, training module 204, evaluate training module 206, testing data 208, and validation data 228. Training data 202 comprises features 210. Training module 204 comprises machine learning module 212, untrained machine learning module 214, weights 216, features 218, and coefficients. The training module 204 trains the untrained machine leaning model 214 using the machine learning module 212 and the training data 202 to generate the weights 216, features 218, and coefficients 220. Evaluate training module 206 comprises adjust features module 222, retrain module 224, and validate module 226. Evaluate training module 206 evaluates whether the untrained machine learning model 214 is adequately trained using test data 208. Evaluate training module 206 may determine to adjust features with the adjust features module 222. Evaluate training module 206 may determine that the untrained machine learning module 214 needs to be retrained. Evaluate training module 206 may determine to validate the untrained machine learning model 214 with the validate module 226, which uses validation data 228. After the untrained machine learning model 214 is determined to be trained sufficiently, then it may be termed a trained machine learning model 406 (FIG. 4).

In some embodiments, machine learning module 212 uses logistic regression (e.g., photon-machine learning, ML) with regularization type L1, L2, or elastic-net. In some embodiments, machine learning module 212 uses binary logistics (e.g., xgboost) with a tree number, maximum tree depth, and learning rate.

The training module 204 is configured to train the untrained machine learning model 214 based on different sets of features 210. For example, adjust features module 222 may be used to determine a different set of features 210 to generate a different set of features 210 for the filtered training members 322, and then the untrained machine learning model 214 may be retrained by the training module 204. Evaluate training module 206 and validate module 226 may then be used to determine how well the untrained machine learning model 214 is operating and compare the results with other untrained machine learning models 214 that were trained with different features 210. The adjust features module 222 may begin with a full set of features 210 and then iterate with different subsets of the full set of features 210. The adjust features module 222 may include performance for features 223, which may be a measure of how well the trained machine learning model 406 performed for a given set of features 210. The evaluate training module 206 may select the feature 210 set that has the best performance for features 223 to use for the trained machine learning model 406 that is used by the prediction model 404 for the connection network system 100. The adjust features module 222 may drop a feature if a value of a corresponding coefficient of the feature is lower than a threshold.

In some embodiments, the training module 204 is configured to find a balance between overfitting and underfitting the training data 202 based on regulations weight of the weights 216. In some embodiments, the training module 205 is configured to use a regularization method (L1, L2, Elastic Net) to find a balance between overfitting and underfitting the training data 202.

Evaluate training module 206 may use one or more of the following methods to evaluate the performance of a trained machine learning model 406 (or untrained machine learning model 214 that is in training). Area under the curve (AUC) of the receiver operating characteristic (ROC) curve where the ROC curve is a graph showing the performance of the trained machine learning model 406 using the testing data 208 and/or validation data 228. The ROC curve may plot true positive rate and a false positive rate. Evaluate training module may use precision-recall (PR). Evaluate training module 206 may use AUC for PR, which is the area under the curve for PR. Precision defines how precise the selections made were. For example, if prediction module 404 determined that eight members 302 were hiring managers 414 (FIG. 4), and actually only five of the eight members 302 were actually hiring managers 414, then the precision would be five divided by eight (5/8). Recall refers to a percentage of the members 302 that are actually hiring managers 414 that are selected by the prediction module 404 out of total number of actual hiring managers 414 that could have been selected from the members 302. For example, if the prediction module 404 selected eight members 302 and only five were actually hiring managers 414, and there were actually 20 hiring managers 414 that could have been selected from the members 302, then the recall is five divided twenty (5/20).

In some embodiments the system 200 is scalable in that the system 200s may determine which features 218 to use to train the untrained machine learning model 214 to determine whether a member 302 is a non-hiring manager 412 or a hiring manager 414.

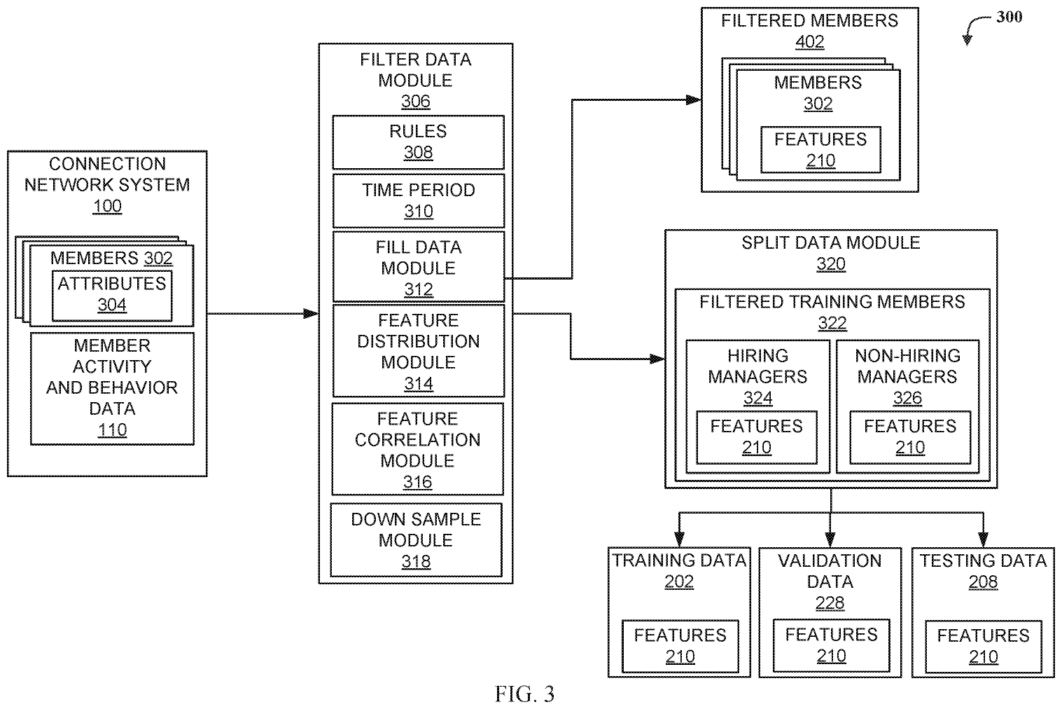

FIG. 3 illustrates a system 300 including the filter data module 306, in accordance with some embodiments. The system 300 includes connection network system 100, filter data module 306, filtered members 402, split data module 320, training data 202, validation data 228, and testing data 208.

The filter data module 306 takes the members 302 and member activity and behaviour data 110 from the connection network system 100 and generates the filtered members 402 and filtered and training members 322. The filtered members 402 may be the members 302 that are used to determine the non-hiring managers 412 and hiring managers 414 from the connection network system 100 that are not part of the filtered training members 322. The filtered members 402 are entered into the predication module 404 to generate an output 408.

The filtered and training members 322 may be termed ground truth, in accordance with some embodiments. The filtered and training members 322 is split into training data 202, validation data 228, and testing data 210, for training (e.g., training module 204), testing (e.g., evaluate training module 206), and validating (e.g., validate module 226), the untrained machine learning model 214.

The filtered and training members 322 includes rules 308, time period 310, fill data module 312, feature distribution module 314, feature correlation module 316, and down sample module 318. Filter data module 306 may be organized differently.

The rules 308 may include one or more of the following. Condition 1: the member 302 indicated a hiring intention in a profile 608 of the member 302, e.g., in a headline of the profile 608, summary of the profile 608, or a post 606 of a feed 604. Condition 2: the member 302 posted a job in the connection network system 100 or a job that was imported into the connection network system 100. Condition 3: the condition 308 may include that the member 302 is a non-talent professional 614, e.g., the position 602 of the member 302 does not indicate a talent professional such as a recruiter, staffing, or human resources employee. In some embodiments, a separate module is used to determine whether the member 302 is a non-talent professional 614, which may be based on the member activity and behaviour data 110 as well as the member 302.

The rules 308 may include a condition that the location 610 of the member 302 indicates a location 610 where English is the main spoken language (or that English is not the main spoken language.)

The time period 310 may include information for the filter data module 306 to determine if the member 302 is engaged 612. For example, the time period 310 may indicate that the member 302 must have been active on the connection network system 100 within the last 30 days. In some embodiments, filter data module 306 may determine whether a member 302 is engaged 612 based on time period 310 and one or more rules 308. For example, that the member 302 has been active in the connection network system 100 in the last 30 days (time period 310) and that the member 302 has viewed at least profile 608 or job posting (rule 308).

In some embodiments, filter data module 306 determines that member 302 may be included in the filtered training members 322 only if the member 302 satisfies condition 1 or condition 2, and condition 3 (i.e., a non-talent professional 614), and the member 302 is an engaged 612 and the location 610 of the member 302 indicates the member 302 is resident in an English speaking location 610. In some embodiments, filter data module 306 may determine that there are approximately 50,000 hiring managers 324 out of the members 302 of the connection network system 100 based on the above rules 308 and time period 310. The 50,000 hiring managers 324 may provide a ground truth from which the untrained learning model 214 can be trained, e.g., trained machine learning model 406. Members 302 who are talent professional are not included as hiring managers 324 since they can have similar behaviour as hiring managers 324, but they are not hiring managers 414. A hiring manager 414 may be the person that is actually the decision make in whether to hire a member 302 for a job.

Only members 302 who are determined to be engaged 612 are included as hiring managers 324. In some embodiments, only about 20 percent of the members 302 of the connection network system 100 are determined to be engaged 612.

In some embodiments, filter data module 306 determines that members 302 may be included in the filtered training members 322 only if the members 302 are determined to be engaged 612, their location 610 indicates they are resident in an English speaking location, and the member 302 is determined to be a non-talent professional 614.

In some embodiments, split data module 320 is configured to split the filtered training members 322 into training data 202, validation data 228, and testing data 208 in a proportion of 3:1:1, respectively.

Down sample module 318 is configured to down sample the members 302 and/or filtered training members 322. The members 302 are imbalanced in that there are far more negative examples of non-hiring managers 326 compared to hiring managers 324. The percentage of hiring managers may be from 0.04% to 0.8% of the member 302, in accordance with some embodiments. The down sample module 318 may reduce the number of non-hiring managers 326 so that the filtered training members 322 is not so biased towards non-hiring managers 326. This may improve the training as described herein and in conjunction with FIG. 2.

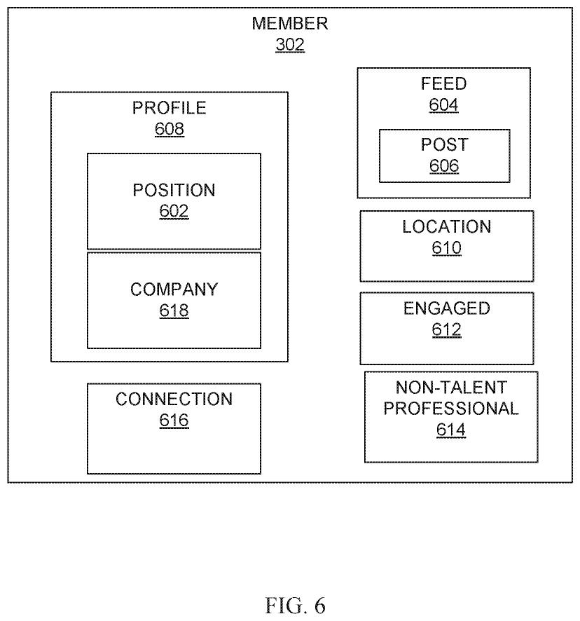

The member 302 shared a job posting in a feed 604 (FIG. 6) of the member 302. The job posting may be a paid job posting where a member 302 paid to post the job on the connection network system 100. The member 302 indicated a hiring intent in a profile 608 of the member 302. The profile 608 of the member 302 may be visible to other members 302 of the connection network system 100. The member 302 indicated a hiring intent in post 606 of the feed 604 of the member 302. The member 302 visits job posting flows. The member 302 shares unpaid job postings in feed 604 of the member 302.

Fill data module 312 is configured to examine the members 302 and member activity and behaviour data 110 and determine if there is missing data in the features 210. Fill data module 312 is configured to remove members 302 if the member 302 is missing data for the features 210. In some embodiments, till data module 312 will fill in missing data rather than not including the member 302.

Feature distribution module 314 is configured to check the distribution of numeric or ordinal features 210 to determine if they are at a same scale as other features 210. Feature distribution module 314 may scale the features 210 so that they are have a similar scale to improve the training as disclosed in conjunction with FIG. 2. Feature distribution module 314 may scale the features 210, e.g., transform feature 210 values to a log value of the value. Feature distribution module 314 may scale the values of the features using one or more of the following: log transformation, scale to unit variance x, scale to [−1,1]x/max|x|, and standardization (x).

Feature correlation module 318 is configured to determine whether features 210 are highly correlated. Feature correlation module 318 may reduce the number of features 210 (e.g., drop a feature 210 or apply principal correlation analysis). Feature correlation model 318 may be configured to determine which features 210 are more important than other features 210. The importance based on a feature's 210 ability to predict whether a member 302 is a hiring manager 324 or not.

In some embodiments, feature correlation module 318 may determine that the top features 210 in terms of predicting accurately whether a member 302 is a hiring manager 324 are (in order of importance) existing job posters (e.g., a member 302 posts a job on the connection network system 100), page views on jobs home (e.g., a member 302 views jobs on a job home page), a number of page views on feed 604 by other members 302, desktop search sessions by the member 302, profile 608 views by 3rd degree connections (e.g., a 3rd degree connection 614 indicates that a first member 302 is connected 614 to a second member 302 who is connected 614 to a third member 302), and a total number of connections 614 a member 302 has. The adjust features module 222 may have selected these features 210 based on the evaluation of feature correlation module 318.

FIG. 4 illustrates a system 400 for determining hiring managers, in accordance with some embodiments. The output 408 may be a continuous output between 0 and 1, which represents the probability of a member 302 being a hiring manager 414 and/or the probability of a member 302 being a non-hiring manager 412. In some embodiments, the output 408 may use different values to indicate a likelihood or probability that the member 302 is a hiring manager 414. In some embodiments, the output 408 may indicate whether the member 302 is a hiring manager 414 or a non-hiring manager 412, e.g., a 1 or “yes” to indicate a hiring manager 414 and 0 or “no” to indicate a non-hiring manager 412. In some embodiments, the connection network system 100 refreshes the output 408 periodically, e.g., each day, to determine whether a member 302 is a non-hiring manager 412 or hiring manager 414.

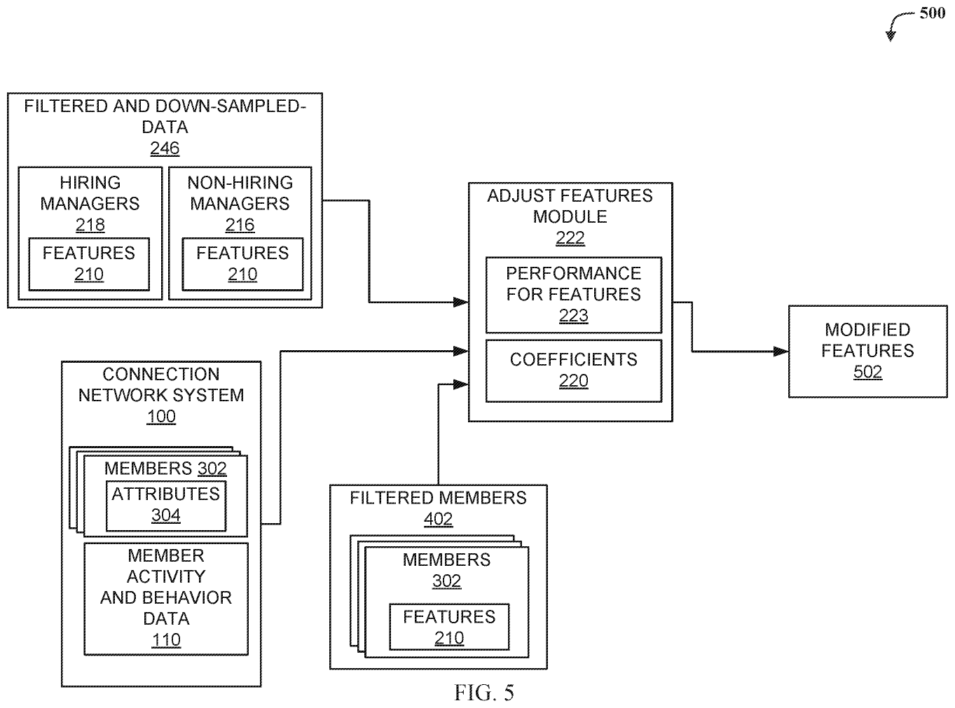

FIG. 5 illustrates a system 500 to adjust features, in accordance with some embodiments. Illustrated in FIG. 5 is filtered and down-sampled-data 246, connection network system 100, filtered members 402, adjust features module 222, and modified features 502. Adjust features 222 may examiner one or more of filtered and down-sampled-data 246, connection network system 100, and filtered members 402 and determine modified features 502.

In some embodiments, there may be 5000 features that can be extracted from the members 302 and member activity and behaviour data 110. In some embodiments, there may be 29 different categories of the features 210, e.g., advertisements, feed, etc. Adjust features module 222 may determine an initial set of features 210 from all the possible features that may be extracted from the connection network system 100.

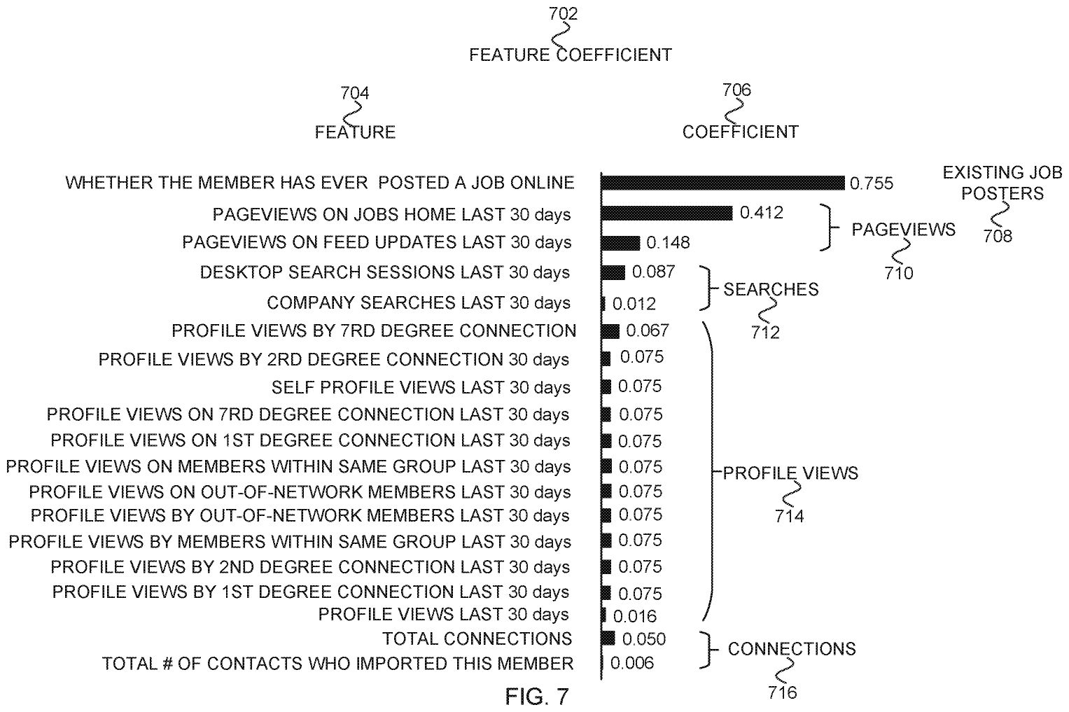

Adjust features module 222 may include performance for features 223 and coefficients 220. Coefficients 220 may determine the coefficients 220 for features 210, e.g., coefficients 702 (FIG. 7). In some embodiments the coefficients 220 are Adjust features module 222 may perform training on the untrained machine learning model 214 for different subsets of features 210 where the features 210 may be selected based on the coefficients 702. Performance for features 223 is configured to determine a performance of the training module 204 based on the modified features 502. In some embodiments, adjust features module 222 may examine the features 210 and eliminate features 210 with low coefficients 220. A value of a coefficient 220 indicates that the relative importance of a corresponding feature of the features 218 in determining output 408, in accordance with some embodiments.

In some embodiments, members 302 that are hiring managers may be seven times more likely to be viewed by other members 302. In some embodiments, members 302 that are hiring managers may be twelve times more likely to view other members 302.

In some embodiments, adjust features module 222 performs feature aggregation, e.g., aggregate daily-activity features based on an aggregation time window such as “last day”, “last 7 days”, etc. In some embodiments, adjust features module 222 transforms feature 210 into numeric features so that they may be more easily trained.

FIG. 6 illustrates a member 302, in accordance with some embodiments. A member 302 may include profile 608, position 602, company 618, connection 616, feed 604, post 606, location 610, engaged 612, and non-talent professional 614. Engaged 612 may be an evaluation whether the member 302 is engaged with the connection network system 100. Non-talent professional 614 may be an evaluation of whether the member 302 is a non-talent professional. Profile 608 may be a profile of the member 302 that may be publicly accessible. The profile 608 may include many fields providing information about the member 302, e.g., position 602 may indicate a job position of the member 302 and company 618 may indicate a company 618 that employs the member 302. Connection 616 may be one or more connections the member 302 has with other members 302. When two members 302 are connected by a connection 616 they may see additional information in the profile 608 and/or may receive posts 606 of the other member 302 in their feed 604. The feed 604 may be information that is presented to the member 302 and may include posts 606 from other members 302 or the connection network system 100. The member 302 may generate his or her own posts 606. The location 610 may indicate a location of the member 302 and may indicate a language that is spoken in that location 610, e.g., English or non-English. Member 302 may include other fields that are not illustrated.

FIG. 7 illustrates feature coefficients 702, in accordance with some embodiments. Illustrated in FIG. 7 is feature 704, coefficient 706, existing job posters 708, pageviews 710, searches 712, profile views 714, and connections 716. FIG. 7 illustrates the coefficient 706 for a feature 704. For example, a coefficient 706 of 0.755 for feature existing job posters 708 (or whether the member has ever posted a job online with a yes).

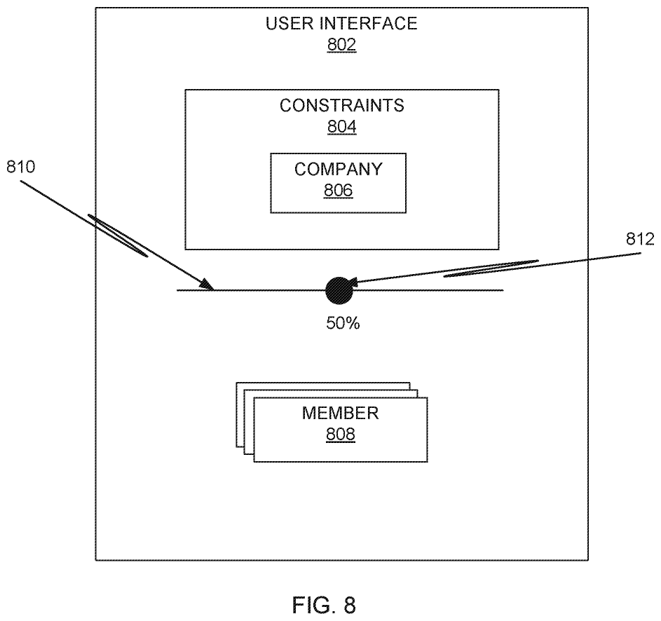

FIG. 8 illustrates a user interface 802 for determining hiring managers, in accordance with some embodiments. Illustrated in FIG. 8 is a user interface 802, constraints 804, company 806, member 808, slider 810, and 50% 812. The constraints 804 may include one or more fields where a user (e.g., another member 302) can enter information for a search of the filtered members 402 (FIG. 4). An example constraint 804 is company 806 so that a company 618 (FIG. 6) that employs the member 302 matches the company 806 indicating as a constraint 804. The slider 810 enables the user to enter a percentage (e.g., 50% 812 as illustrated) for the threshold that is used as the threshold for above a threshold 410 (FIG. 4). The slider 810 may be another interaction displayed for the user to adjust the percentage 812. Member 808 indicates members 302 (FIG. 4) that are determined to be hiring managers 414 based on matching the constraints 804 with a threshold of 50% 812. The system 400 is used to determine whether filtered members 402 that match the constraints 804 are determined to be hiring managers 414 or not based on the threshold (here 50% 812) being used at above a threshold 410.

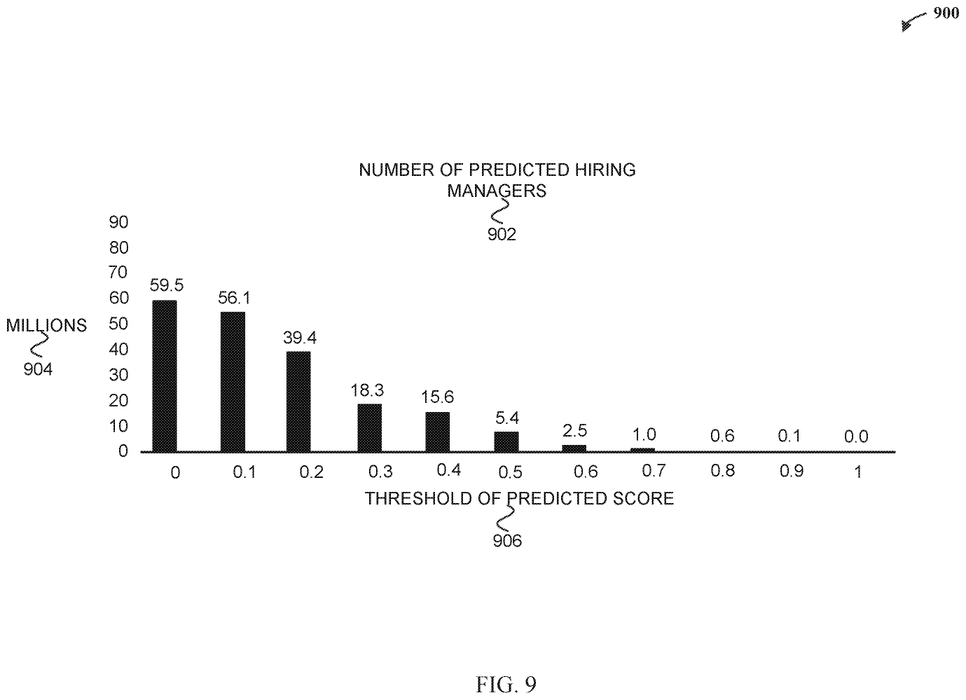

FIG. 9 illustrates a graph 900 of a number of predicted hiring managers as a function of a value of the threshold, in accordance with some embodiments. Illustrated in FIG. 9 number of predicted hiring managers 902, millions 904 (of member 302), and threshold 906. Number of predicted hiring managers 902 is a title of the graph 900. The millions 904 indicates the number of members 302 of filtered members 402 (FIG. 4) that are predicted to be hiring managers 414 by the prediction module 404 based on the threshold 906. The threshold 906 may be tested at above a threshold 410 (FIG. 4). The threshold 906 may be the same or similar as output 408. The number of members 302 of filtered members 402 that were used to generate the graph 900 may be approximately 600 million. A threshold 906 value of 0.5 includes 80 percent of the filtered training members 322 that are indicated as hiring managers 324, i.e., if a member 302 is identified as a hiring manager 324 by filter data module 306 for use in the filtered training members 322, then with a threshold 906 value of 0.5 (e.g., a threshold of 0.5 of FIG. 4), there is an 80 percent chance that the member 302 will be identified as a hiring manager 414.

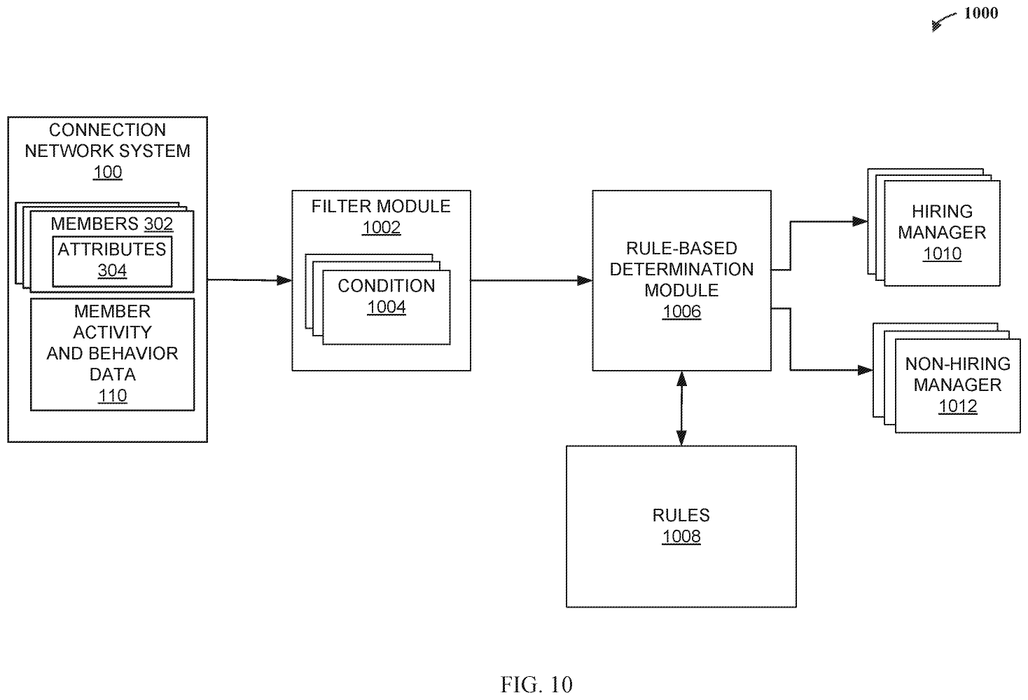

FIG. 10 illustrates a rule-based system to determine hiring managers 1000, in accordance with some embodiments. Illustrated in FIG. 10 is connection network system 100, filter module 1002, rule-based determination module 1006, rules 1008, hiring manager 1010, and non-hiring manager 1012. Filter module 1002 examiners members 302 of the connection network system 1002 and filters them based on the conditions 1004. The conditions 1004 may include that the member 302 is from an English-speaking country or resident in an English speaking country. The conditions 1004 may include that the member 302 is from a non-English-speaking country. The conditions 1004 may include that the member 302 is not identified as a talent professional (TP). For example, if the position 602 of the member 302 indicates the member 302 is a recruiter, then the member 302 is filtered out by the filter module 1002.

The rule-based determination module 1006 is configured to use the rules 1008 and determine whether a member 302 that is not filtered out by the filter module 1002 is a hiring manager 1010 or non-hiring manager 1012. The rule-based determine module 1006 may determine that a member 302 is a hiring manager 1010 if the member 302 satisfies one or more of the rules 1008. In some embodiments, the rule-based determination module 1006 determines that a member 302 is a non-hiring manager 1012 if the member 302 does not satisfy a predetermined number of the rules 1008. The predetermined number may be one or more. In some embodiments, the rule-based determination module 1006 may be configured to give a weighting to each of the rules 1008 and then determine whether the member 302 is a hiring manager 1010 or a non-hiring manage 1012 based on whether a sum of the rules 1008 that the member 302 matched times its weighting is above a threshold.

The rules 1008 may include one or more of the following. The member 302 shared a job posting in a feed 604 (FIG. 6) of the member 302. The job posting may be a paid job posting where a member 302 paid to post the job on the connection network system 100. The member 302 indicated a hiring intent in a profile 608 of the member 302. The profile 608 of the member 302 may be visible to other members 302 of the connection network system 100. The member 302 indicated a hiring intent in post 606 of the feed 604 of the member 302. The member 302 visits job posting flows. The member 302 shares unpaid job postings in feed 604 of the member 302.

In some embodiments, the rule-based system to determine hiring managers 1000 may identify approximately 0.14% of the members 302 as hiring managers 1010. In some embodiments, the rule-based system to determine hiring managers 1010 identifies approximately 0.18% of English-speaking resident members 302 as hiring managers 1010 and approximately 0.07 non-English-speaking resident members 302 as hiring managers 1010. Determining the rules 1008 may be difficult and not scalable as the rules 1008 may need to be changed as the connection network system 1000 adds new features. Moreover, it may be difficult to determine what rules 1008 should be used.

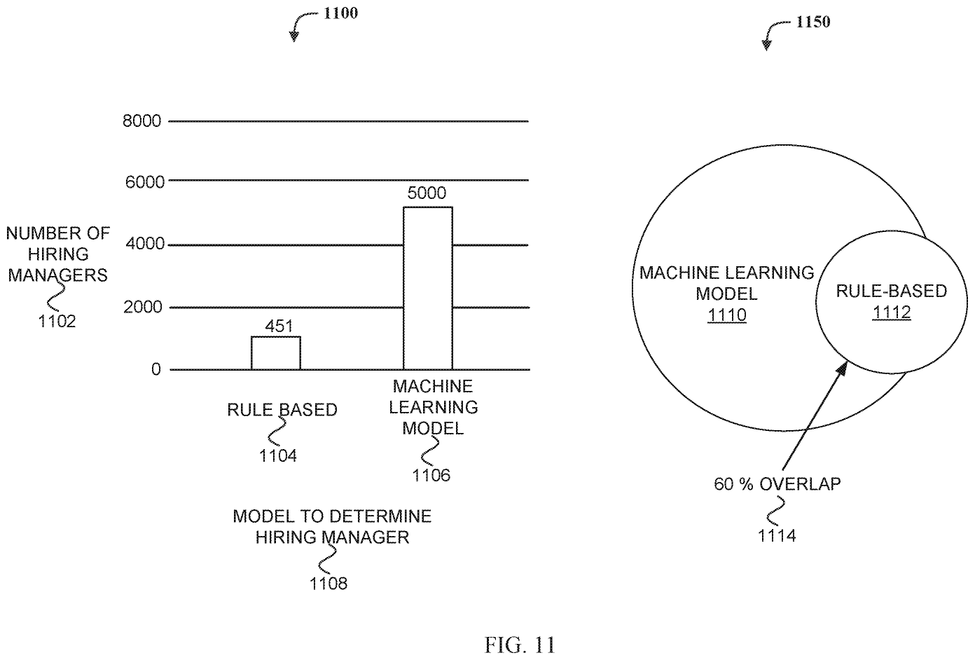

FIG. 11 illustrates a comparison 1100, 1150 of the rule-based system to determine hiring managers 1000 vs. the prediction model 404, in accordance with some embodiments. Illustrated in comparison 1100 is number of hiring managers 1102, rule based 651, machine learning model 1106, and model to determine hiring manager 1108. Illustrated in comparison 1150 is machine learning model hiring 1110, rule based 1112, and 60% overlap 1114.

The number of hiring managers 1102 is the number of members 302 that have been determined to be hiring managers (hiring managers 1010 of FIG. 10 for rule-based system to determine hiring managers 1000 and hiring manager 414 of FIG. 4 for prediction module 404 using a trained machine learning model 406). Rule based 1104 determine 651 members 302 a number of hiring managers 1102 as 651 and the machine learning model 1106 determines a number of hiring managers 1102 as 5000. The machine learning model 1106 is then better at determining hiring managers than the rule based 1104 by a factor of about 11.

Illustrated in comparison 1150 is machine learning model hiring 1110, rule based 1112, and 60% overlap 1114. The size of machine learning model 1110 and rule based 1112 indicates a number of members 302 (7000 and 651, respectively) that have been determined to be hiring managers (hiring managers 1010 of FIG. 10 for rule-based system to determine hiring managers 1000 and hiring manager 414 of FIG. 4 for prediction module 404 using a trained machine learning model 406). The 60% overlap 1114 indicates that there is a 60% overlap between the rule based 1112 hiring managers and the machine learning model 1110 hiring managers.

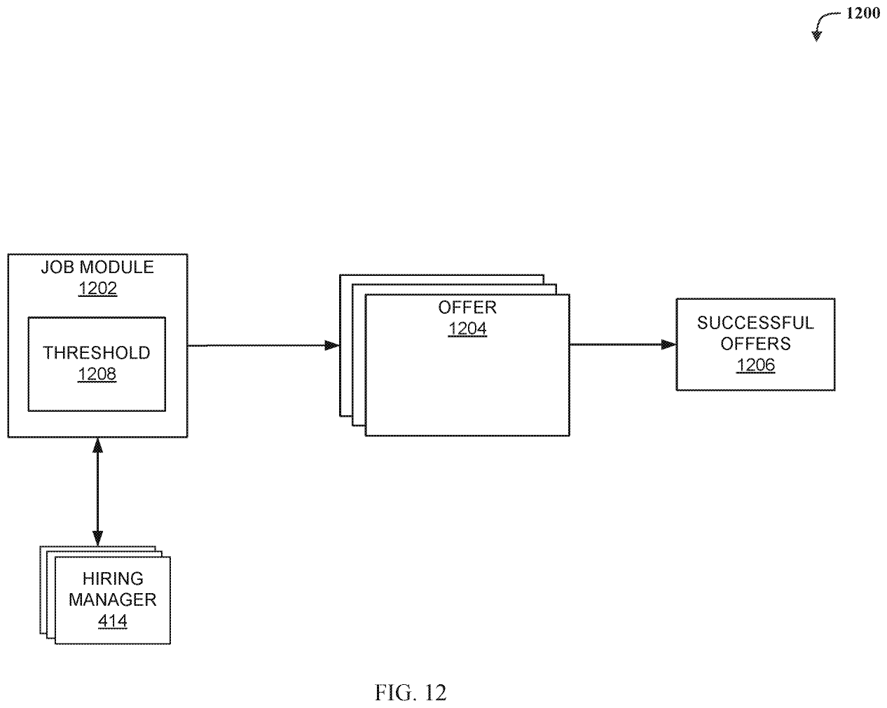

FIG. 12 illustrates a system 1200 for generating successful offers 1206, in accordance with some embodiments. Illustrated in FIG. 12 is job module 1202, offers 1204, successful offers, and hiring managers 414. The job module 1202 may generate offers 1204 to hiring managers 414. The hiring managers 414 may accept the offers 1204 to generate successful offers 1206. The job module 1202 may restrict or focus the offers based on member 302 of the connection network system 100 being determined to be hiring managers 414 (FIG. 4). The job module 1202 may adjust a threshold 1208 based on the type of offer 1204 being made. The offer 1204 may be an advertisement, a connection with another member 302 offer, an offer to post a job, etc.

In some embodiments, it is important not to make an offer 1204 to a member 302 of the connection network system 100 often as it may be annoying and tend to decrease the use of the connection network system 100 if offers 1204 are made that the member 302 does not accept.

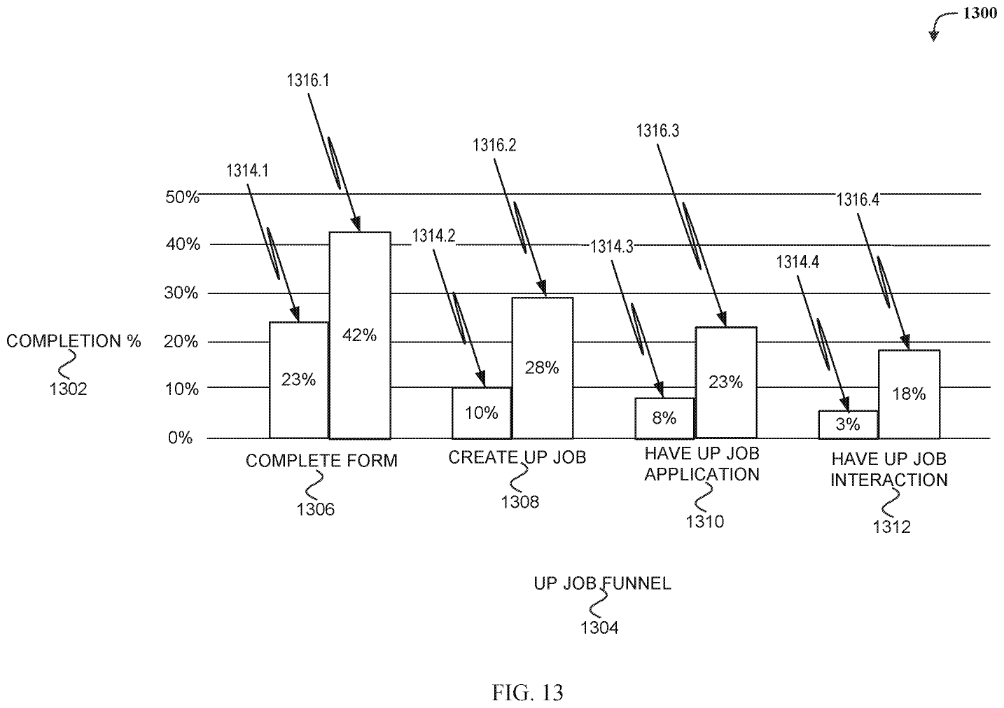

FIG. 13 illustrates a graph 1300 of an ubiquitous participation (UP) job funnel with different hiring manager scores, in accordance with some embodiments. Illustrated in FIG. 13 is completion % 1302, UP job funnel 1304, complete form 1306, create UP job 1308, have UP job application 1310, have UP job interaction 1312, FIM score 0.1-0.2 1314, and HM score 0.9-1 1316. The completion % 1302 indicates a complete rate for the users 302 that complete form 1306, create UP job 1308, have UP job application 1310, and have UP job interaction 1312. The UP job funnel 1304 indicates different stages of UP jobs, e.g., complete form 1306, create UP job 1308, have UP job 1308, and have UP job interaction 1312. Complete form 1306 indicates that the member 302 has completed a form for UP job. Create UP job 1308 indicates that the member 302 has created a UP job. Have UP job application 1310 indicates that the member 302 has a UP job application. Have UP job interaction 1312 indicates the member 302 has interacted with a UP job. MI score 0.1-0.2 1314 indicates that a member 302 has an output 408 of between 0.1-0.2. HM score 0.9-1 1316 indicates that the member 302 has an output 408 of between 0.9-1. Graph 1300 illustrates that at each point complete form 1306, create UP job 1308, have UP job application 1310, and have UP job interaction 1312 in the UP job funnel 1304 that members 302 with a higher output 408 have a higher complete % 1302, e.g., 2×, 3×, 3×, and 7×, respectively. In some embodiments, UP job is a job that is shared in a feed of hiring manager. The UP job may be submitted to the connection network system 100 without paying for submitting the job, in accordance with some embodiments.

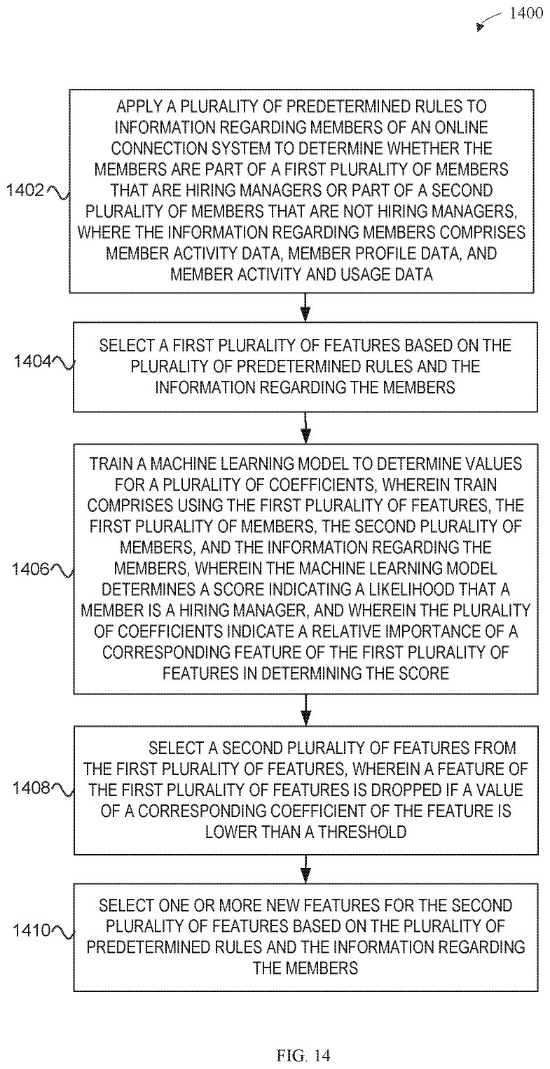

FIG. 14 illustrates a method 1400 for dynamic selection of features for training a machine learning model, in accordance with some embodiments. The method 1400 begins at operation 1402 with applying a plurality of predetermined rules to information regarding members of an online connection system to determine whether the members are part of a first plurality of members that are hiring managers or part of a second plurality of members that are not hiring managers, where the information regarding members comprises member activity data, member profile data, and member activity and usage data. For example, filter data module 306 may determine using rules 308 filtered training members 322 from the connection network system 100. Filtered training member 322 includes hiring managers 324 and non-hiring managers 326. In another example, people may verify or determine a set of hiring managers.

The method 1400 continues at operation 1404 with selecting a first plurality of features based on the plurality of predetermined rules and the information regarding the members. For example, features 218 or adjust features 222 may determine features 210 to use to train the untrained machine learning model 214.

The method 1400 continues at operation 1406 with training a machine learning model to determine values for a plurality of coefficients, where train comprises using the first plurality of features, the first plurality of members, the second plurality of members, and the information regarding the members, where the machine learning model determines a score indicating a likelihood that a member is a hiring manager, and where the plurality of coefficients indicate a relative importance of a corresponding feature of the first plurality of features in determining the score. For example, the coefficients 220 may be determine during the training of the untrained machine learning model 214 by the training module 204. In some embodiments, coefficients 220 determines the coefficients, e.g., coefficients 706 of FIG. 7.

The method 1400 continues at operation 1408 with selecting a second plurality of features from the first plurality of features, where a feature of the first plurality of features is dropped if a value of a corresponding coefficient of the feature is lower than a threshold. The method 1400 continues at operation 1410 with selecting one or more new features for the second plurality of features based on the plurality of predetermined rules and the information regarding the members. For example, adjust features module 222 may determine modified features 502 based on the features 210, coefficients 220, and connection network system 100.

In some embodiments, method 1400 continues with iterating by finding new features and training the machine learning model with the new features, and then testing whether the net model is acceptable. For example, retrain module 224 and/or validate module 226 may determine to stop training and use a set of features 210 based on determining the output 408 of the testing data 208 and/or validation data 228 and determining an error measure is below a threshold.

Method 1400 may include one or more additional operations. One or more of the operations of method 1400 may be performed in a different order. One or more of the operations of method 1400 may be optional.

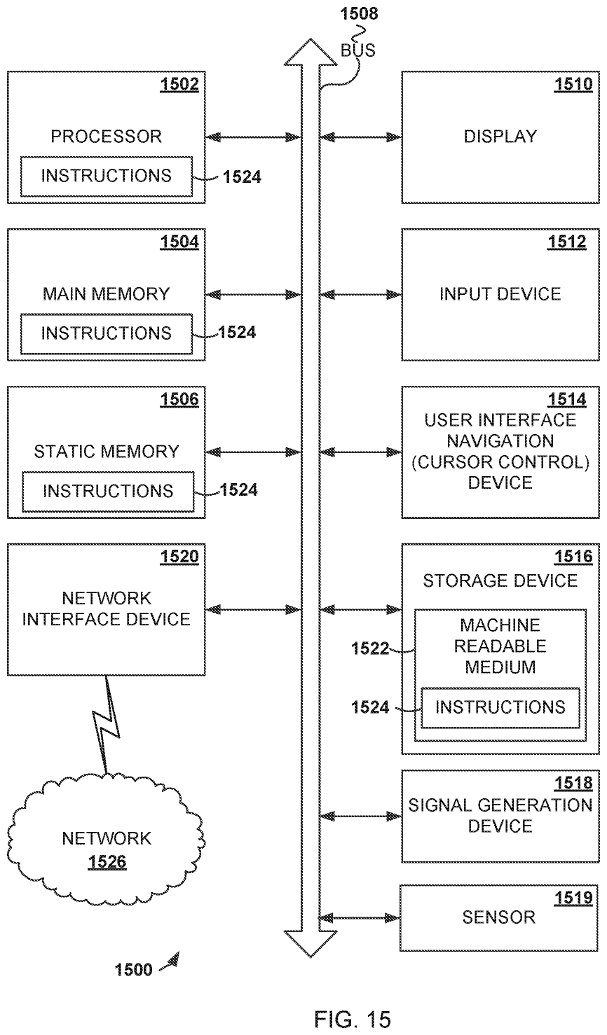

FIG. 15 shows a diagrammatic representation of the machine 1500 in the example form of a computer system and within which instructions 1524 (e.g., software) for causing the machine 1500 to perform any one or more of the methodologies discussed herein may be executed. In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a peer-to-peer (or distributed) network environment. The machine 1500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1524, sequentially or otherwise, that specify actions to be taken by that machine. Further, while only a single machine is illustrated, the term “machine” shall also be taken to include a collection of machines that individually or jointly execute the instructions 1524 to perform any one or more of the methodologies discussed herein in conjunction with FIGS. 1-14.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The machine 1500 may further include a graphics display 1510 (e.g., a plasma display panel (PDP), a light emitting diode (LED) display, a liquid crystal display (LCD), a projector, or a cathode ray tube (CRT)). The machine 1500 may also include an alphanumeric input device 1512 (e.g., a keyboard), a user interface navigation (cursor control) device 1514 (e.g., a mouse, a touchpad, a trackball, a joystick, a motion sensor, or other pointing instrument), a storage device 1516, a signal generation device 1518 (e.g., a speaker), a network interface device 1520, sensor 1519. Sensor 1519 may be a camera, a light sensor, sound sensor, etc.

The storage device 1516 includes a machine-readable medium 1522 on which is stored the instructions 1524 (e.g., software) embodying any one or more of the methodologies or functions described herein. The instructions 1524 may also reside, completely or at least partially, within the main memory 1504, within the processor 1502 (e.g., within the processor's cache memory), or both, during execution thereof by the machine 1500. Accordingly, the main memory 1504 and the processor 1502 may be considered as machine-readable media. The instructions 1524 may be transmitted or received over a network 1526 via the network interface device 1520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1500), such that the instructions, when executed by one or more processors of the machine (e.g., processor 1502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently, configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A machine-readable medium storing computer-executable instructions stored thereon that, when executed by at least one hardware processor, cause the at least one hardware processor to perform a plurality of operations, the operations comprising:
apply a plurality of predetermined rules to information regarding members of an online connection system to determine whether the members are part of a first plurality of members that are hiring managers or part of a second plurality of members that are not hiring managers, wherein the information regarding members comprises member activity data, member profile data, and member activity and usage data;
select a first plurality of features based on the plurality of predetermined rules and the information regarding the members;
train a machine learning model to determine values for a plurality of coefficients, wherein train comprises using the first plurality of features, the first plurality of members, the second plurality of members, and the information regarding the members, wherein the machine learning model determines a score indicating a likelihood that a member is a hiring manager, and wherein the plurality of coefficients indicate a relative importance of a corresponding feature of the first plurality of features in determining the score;
select a second plurality of features from the first plurality of features, wherein a feature of the first plurality of features is dropped if a value of a corresponding coefficient of the feature is lower than a threshold; and
select one or more new features for the second plurality of features based on the plurality of predetermined rules and the information regarding the members.

2. The machine-readable medium of claim 1, wherein the threshold is a first threshold, and wherein the plurality of operations further comprises:
cause a user interface to be displayed on a computer display, wherein the user interface is configured to enable a user to select a value for a second threshold; and
in response to a selection of the value for the second threshold by the user, determine scores for members of the online connection network using the machine learning model, and display to the user on the computer display members that have a score greater than the value of the second threshold.

3. The machine-readable medium of claim 1, wherein the plurality of coefficients is a first plurality of coefficients, and wherein the plurality of operations further comprises:
train the machine learning model to determine values for a second plurality of coefficients, wherein the train uses the second plurality of features;
determine whether the machine learning model trained using the second plurality of features performs better than the machine learning model trained based on the first plurality of features;
in response to a determination that the machine learning model trained based on the second plurality of features performs better than the machine learning model trained based on the first plurality of features, select a third plurality of features from the second plurality of features, wherein a feature of the second plurality of features is dropped if a value of a corresponding coefficient of the feature is lower than the threshold, and select one or more new features for the third plurality of features based on the plurality of predetermined rules and the information regarding the members; and
in response to a determination that the machine learning model trained based on the first plurality of features performs better than the machine learning model trained based on the second plurality of features, select a third plurality of features from the first plurality of features, wherein a feature of the first plurality of features is dropped if a value of a corresponding coefficient of the feature is lower than the threshold, and select one or more new features for the third plurality of features based on the plurality of predetermined rules and the information regarding the members.

4. The machine-readable medium of claim 3, wherein determine whether the machine learning model trained using the second plurality of features performs better than the machine learning model trained based on the first plurality of features further comprises:
split the first plurality of members into a third plurality of members and a fourth plurality of members;
determine first scores for the third plurality of members using the machine learning model trained based on the second plurality of features;
determine second scores for the fourth plurality of members using the machine learning model trained based on the first plurality of features; and
in response to a number of second scores being above the threshold being greater than a number of first scores being above the threshold, determine the machine learning model trained using the second plurality of features performs better than the machine learning model trained based on the first plurality of features.

5. The machine-readable medium of claim 1, wherein the plurality of operations further comprises:
determine a threshold value to use;
determine scores using the machine learning model for each of the members of the online connection network;
cause to be displayed on a computer screen an offer to post a job for members that have a score greater than the threshold, wherein members having a score greater than the threshold are determined to be hiring manager with a likelihood greater than the threshold value.

6. The machine-readable medium of claim 1, wherein the plurality of predetermined rules comprise an indication that a member is a hiring manager if one or more of the following group is true: a member indicates a hiring intention in a profile of the a feed of the member, the member posted a job posting within the online connection system, the member is determined to be a non-talent professional, the member is determined to be an engaged member, the member is determined to reside in an English speaking country, and the profile of the member has a threshold number of information fields out of a plurality of information fields completed.

7. The machine-readable medium of claim 1, wherein the machine learning model is based on logistic regression or binary logistics.

8. The machine-readable medium of claim 1, wherein select one or more new features for the second plurality of features further comprises:
randomly select features from the information regarding the members, wherein features that are part of the first plurality of features are excluded.

9. The machine-readable medium of claim 1, wherein the plurality of operations further comprises:
assigning numeric values to each value of the first plurality of features, wherein the numeric values are based on a same scale of values.

10. The machine-readable medium of claim 1, wherein the plurality of operations further comprises:
train the machine learning model to determine values for a second plurality of coefficients, wherein the train uses the second plurality of features;
determine whether a performance of the machine learning model trained based on the second plurality of features performs above threshold value;
in response to a determination that the performance is above the threshold value, use the machine learning model trained based on the second plurality of features for determining scores for members of the online connection system; and
in response to a determination that the performance is not above the threshold value, select a third plurality of features from the first plurality of features, wherein a feature of the second plurality of features is dropped if a value of a corresponding coefficient of the feature is lower than the threshold, select one or more new features for the third plurality of features based on the plurality of predetermined rules and the information regarding the members.

11. A computer-implemented method comprising:
applying a plurality of predetermined rules to data regarding members of an online connection system to determine whether the members are part of a first plurality of members that are hiring managers or part of a second plurality of members that are not hiring managers, wherein the data regarding members comprises member activity data, member profile data, and member activity and usage data;
selecting a first plurality of features based on the plurality of predetermined rules and the data regarding the members;
training a machine learning model to determine values for a plurality of coefficients, wherein the train uses the first plurality of features, the first plurality of members, the second plurality of members, and the data regarding the members, wherein the machine learning model determines a score indicating a likelihood that a member is a hiring manager, and wherein the plurality of coefficients indicate a relative importance of a corresponding feature of the first plurality of features in determining the score;
selecting a second plurality of features from the first plurality of features, wherein a feature of the first plurality of features is dropped if a value of a corresponding coefficient of the feature is lower than a threshold; and
selecting one or more new features for the second plurality of features based on the plurality of predetermined rules and the information regarding the members.

12. The computer-implemented method of claim 11 further comprising:
causing a user interface to be displayed on a computer display, wherein the user interface is configured to enable a user to select a value for a second threshold; and
in response to a selection of the value for the second threshold by the user, determining scores for members of the online connection network using the machine learning model, and displaying to the user on the computer display members that have a score greater than the value of the second threshold.

13. The computer-implemented method of claim 11 wherein the plurality of coefficients is a first plurality of coefficients, and wherein the method further comprises:
training the machine learning model to determine values for a second plurality of coefficients, wherein the train uses the second plurality of features;
determining whether the machine learning model trained using the second plurality of features performs better than the machine learning model trained based on the first plurality of features;
in response to a determination that the machine learning model trained based on the second plurality of features performs better than the machine learning model trained based on the first plurality of features, selecting a third plurality of features from the second plurality of features, wherein a feature of the second plurality of features is dropped if a value of a corresponding coefficient of the feature is lower than the threshold, and selecting one or more new features for the third plurality of features based on the plurality of predetermined rules and the information regarding the members; and
in response to a determination that the machine learning model trained based on the first plurality of features performs better than the machine learning model trained based on the second plurality of features, selecting a third plurality of features from the first plurality of features, wherein a feature of the first plurality of features is dropped if a value of a corresponding coefficient of the feature is lower than the threshold, and selecting one or more new features for the third plurality of features based on the plurality of predetermined rules and the information regarding the members.

14. The computer-implemented method of claim 13, wherein determining whether the machine learning model trained using the second plurality of features performs better than the machine learning model trained based on the first plurality of features further comprises:
splitting the first plurality of members into a third plurality of members and a fourth plurality of members;
determining first scores for the third plurality of members using the machine learning model trained based on the second plurality of features;
determining second scores for the fourth plurality of members using the machine learning model trained based on the first plurality of features; and
in response to a number of second scores being above the threshold being greater than a number of first scores being above the threshold, determining the machine learning model trained using the second plurality of features performs better than the machine learning model trained based on the first plurality of features.

15. The computer-implemented method of claim 11, wherein the method further comprises:
determining a threshold value to use;
determining scores using the machine learning model for each of the members of the online connection network;
causing to be displayed on a computer screen an offer to post a job for members that have a score greater than the threshold, wherein members having a score greater than the threshold are determined to be hiring manager with a likelihood greater than the threshold value.

16. A system for returning determining hiring managers in an online connection system, the system comprising:
apply a plurality of predetermined rules to data regarding members of an online connection system to determine whether the members are part of a first plurality of members that are hiring managers or part of a second plurality of members that are not hiring managers, wherein the data regarding members comprises member activity data, member profile data, and member activity and usage data;
select a first plurality of features based on the plurality of predetermined rules and the data regarding the members;
train a machine learning model to determine values for a plurality of coefficients, wherein the train uses the first plurality of features, the first plurality of members, the second plurality of members, and the data regarding the members, wherein the machine learning model determines a score indicating a likelihood that a member is a hiring manager, and wherein the plurality of coefficients indicate a relative importance of a corresponding feature of the first plurality of features in determining the score;
select a second plurality of features from the first plurality of features, wherein a feature of the first plurality of features is dropped if a value of a corresponding coefficient of the feature is lower than a threshold; and
select one or more new features for the second plurality of features based on the plurality of predetermined rules and the information regarding the members.

17. The system of claim 16, wherein the threshold is a first threshold, and wherein the instructions further cause the system to:
cause a user interface to be displayed on a computer display, wherein the user interface is configured to enable a user to select a value for a second threshold; and
in response to a selection of the value for the second threshold by the user, determine scores for members of the online connection network using the machine learning model, and display to the user on the computer display members that have a score greater than the value of the second threshold.

18. The system of claim 16, wherein the plurality of coefficients is a first plurality of coefficients, and wherein the instructions further cause the system to:
train the machine learning model to determine values for a second plurality of coefficients, wherein the train uses the second plurality of features;
determine whether the machine learning model trained using the second plurality of features performs better than the machine learning model trained based on the first plurality of features;
in response to a determination that the machine learning model trained based on the second plurality of features performs better than the machine learning model trained based on the first plurality of features, select a third plurality of features from the second plurality of features, wherein a feature of the second plurality of features is dropped if a value of a corresponding coefficient of the feature is lower than the threshold, and select one or more new features for the third plurality of features based on the plurality of predetermined rules and the information regarding the members; and
in response to a determination that the machine learning model trained based on the first plurality of features performs better than the machine learning model trained based on the second plurality of features, select a third plurality of features from the first plurality of features, wherein a feature of the first plurality of features is dropped if a value of a corresponding coefficient of the feature is lower than the threshold, and select one or more new features for the third plurality of features based on the plurality of predetermined rules and the information regarding the members.

19. The system of claim 16, wherein determine whether the machine learning model trained using the second plurality of features performs better than the machine learning model trained based on the first plurality of features further comprises:
split the first plurality of members into a third plurality of members and a fourth plurality of members;
determine first scores for the third plurality of members using the machine learning model trained based on the second plurality of features;
determine second scores for the fourth plurality of members using the machine learning model trained based on the first plurality of features; and
in response to a number of second scores being above the threshold being greater than a number of first scores being above the threshold, determine the machine learning model trained using the second plurality of features performs better than the machine learning model trained based on the first plurality of features.

20. The system of claim 16, Wherein the instructions further cause the system to:
determine a threshold value to use;
determine scores using the machine learning model for each of the members of the online connection network;
cause to be displayed on a computer screen an offer to post a job for members that have a score greater than the threshold, wherein members having a score greater than the threshold are determined to be hiring manager with a likelihood greater than the threshold value.
